(19) United States
(12) Patent Application Publication
(10) Pub. No.: US 2024/0236062 A9
(43) Pub. Date: Jul. 11, 2024

(54) SYSTEMS AND METHODS FOR ANONYMIZED VALIDATION AND LOGIN

(71) Applicant: Capital One Services, LLC, McLean, VA (US)

(72) Inventors: Jeffrey Carlyle WIEKER, Falls Church, VA (US); Clayton JOHNSON, Edgewood, MD (US); Kevan EMMOTT, Arlington, VA (US)

(73) Assignee: Capital One Services, LLC, McLean, VA (US)

(21) Appl. No.: 18/047,887

(22) Filed: Oct. 19, 2022

(51) Int. Cl. H04L 9/40; G06F 21/62

(52) U.S. Cl. CPC H04L 63/08; G06F 21/6254

(57) ABSTRACT

A method for facilitating anonymized interactions and/or identifying or validating a user via a virtual number may include: receiving a login request from a user device associated with a user that identifies the user via a virtual number; in response to receiving the login request, determining whether the virtual interaction item number is valid; in response to determining that it is valid: validating the login request; and identifying an entity associated with the virtual number; receiving from the user device, an interaction-completion request; in response to receiving the interaction-completion request, transmitting a user information request to the entity associated with the virtual number; receiving a reply to the user-information request from the entity; and in response to receiving the reply, completing the interaction-completion request using the reply.

### TECHNICAL FIELD

Various embodiments of this disclosure relate generally to techniques for anonymized validation and login of a user, and, more particularly, to systems and methods for anonymizing interactions using a virtual number.

### BACKGROUND

Many online interactions use or even depend on identification information. Such interactions, however, may impose risks, both for a user providing identifying information and for an entity receiving such information. For example, while receiving entities are generally tasked with protecting the information they receive, data breaches have become more and more common. Further, measures to mitigate the risk of a data breach may increase the difficulty, complexity, or cost of managing such data. Moreover, a user may generally interact with many entities, meaning that their identifying information may pass to many entities and thus create many vectors of risk. Even if some entities protect their data, others may not, and the user may remain at risk. And, while some techniques have been developed to address concerns such as the foregoing, such as two-factor authentication, such approaches generally have a negative impact on the interaction between the user and the entity such as extra steps, extra complexity, or the like.

This disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for anonymized validation and login of a user by using a virtual number.

In one aspect, an exemplary embodiment of a method for facilitating anonymized interactions and/or identifying or validating a user via a virtual number may include: receiving, via at least one processor of a server system, a login request from a user device associated with a user, the login request identifying the user via a virtual interaction item number; in response to receiving the login request, determining, via the at least one processor, whether the virtual interaction item number is valid; in response to determining that the virtual interaction item number is valid: validating the login request; and identifying an entity associated with the virtual interaction item number; receiving, via the at least one processor and from the user device, an interaction-completion request; in response to receiving the interaction-completion request, transmitting a user information request to the entity associated with the virtual interaction item number; receiving a reply to the user-information request from the entity associated with the virtual interaction item number; and in response to receiving the reply, completing the interaction-completion request using the reply.

In another aspect, an exemplary embodiment of a system for facilitating anonymized interactions may include: at least one processor; and at least one memory operatively connected to the at least one processor, and storing instructions executable by the at least one processor to perform operations. Such operations may include: receiving a login request from a user device associated with a user, the login request identifying the user via a virtual interaction item number; in response to receiving the login request, determining whether the virtual interaction item number is valid; in response to determining that the virtual interaction item number is valid: validating the login request; and identifying an entity associated with the virtual interaction item number; receiving, from the user device, an interaction-completion request; in response to receiving the interaction-completion request, transmitting a user information request to the entity associated with the virtual interaction item number; receiving a reply to the user-information request from the entity associated with the virtual interaction item number; and in response to receiving the reply, completing the interaction-completion request using the reply.

In a further aspect, an exemplary embodiment of a computer-implemented method for anonymized interactions may include: receiving, via at least one processor of a server system, a login request from a user device associated with a user, the login request identifying the user via a virtual interaction item number; in response to receiving the login request, determining, via the at least one processor, whether the virtual interaction item number is valid; in response to determining that the virtual interaction item number is valid: validating the login request; identifying an entity associated with the virtual interaction item number; and initiating a session associated with the virtual interaction item number for the user device; receiving, via the at least one processor and from through the session associated with the virtual interaction item number, an interaction-completion request; in response to receiving the interaction-completion request, transmitting a user information request to the entity associated with the virtual interaction item number; receiving a reply to the user-information request from the entity associated with the virtual interaction item number; in response to receiving the reply, completing the interaction-completion request using the reply and the virtual interaction item number; and after completing the interaction-completion request, one or more of deleting or removing access to information included in the reply.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for facilitating anonymized interactions and/or identifying or validating a user via a virtual number, according to one or more embodiments.

FIG. 2 depicts a flowchart of an exemplary method of facilitating anonymized interactions and/or identifying or validating a user via a virtual number, according to one or more embodiments.

FIG. 3 depicts a flowchart of another exemplary method of facilitating anonymized interactions and/or identifying or validating a user via a virtual number, according to one or more embodiments.

FIG. 4 depicts an example of a computing device, according to one or more embodiments.

### DETAILED DESCRIPTION OF EMBODIMENTS

According to certain aspects of the disclosure, methods and systems are disclosed for anonymized user validation and login, e.g., using a virtual number such as a virtual interaction number or virtual credit card number. As will be discussed in more detail below, in various embodiments, systems and methods are described for anonymized user validation and login.

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Terms like “provider,” “merchant,” “vendor,” or the like generally encompass an entity or person involved in providing, selling, and/or renting items to persons such as a seller, dealer, renter, merchant, vendor, or the like, as well as an agent or intermediary of such an entity or person. An “item” generally encompasses a good, service, or the like having ownership or other rights that may be transferred. As used herein, terms like “user” or “customer” generally encompasses any person or entity that may desire information, resolution of an issue, purchase of a product, or engage in any other type of interaction with a provider. The term “browser extension” may be used interchangeably with other terms like “program,” “electronic application,” or the like, and generally encompasses software that is configured to interact with, modify, override, supplement, or operate in conjunction with other software. As used herein, terms such as “virtual number,” “virtual credit card number,” “virtual interaction item number,” or the like generally encompass a limited use code or number that is generally usable in lieu of and tied to an existing user account such as a credit account or credit card number.

Conventionally, completing an interaction with an entity, e.g., an online merchant or vendor, requires that a user provide identifying information. For example, the user may need to provide address information in order for a delivery to be made. Further, even when no physical item may be involved, an interaction may still require identification and validation of the user, e.g., for the purpose of submitting payment information, verifying that the user is authentic or non-fraudulent, etc. In some cases, a user may provide identifying information, e.g., to create an account associated with an entity, and then login to the account at a later instance in order to complete an interaction using the previously provided identifying information. In some cases, a user may not provide identifying information until an interaction is near or at completion, e.g., by using a guest login or by completing an interaction as a guest. Nevertheless, at some point, in order to complete the interaction, the user must provide the identifying information required. Not only does this mean that the entity receiving the identifying information is tasked with responsible management of such data, but also that the user is increasingly at risk for each different entity that the user interacts with due to the increasing risk of data breaches and fraud.

In an exemplary use case, an entity, e.g., an online merchant, may host an online resource, e.g., a website having an e-commerce store, on a server system. At least some activity on the online resource may rely on identifying information of the user. For example, a user's address and/or payment information may be needed in order to complete an interaction including purchase and delivery of an item to the user. The online resource may be configured to receive a request from a user to access such an activity, e.g., via a login. For example, a user operating a user device may navigate to the online resource, which may output an interactive interface configured to receive login information from the user. In this example, the login may occur upon the user navigating to the online resource via the user device. However, it should be understood that a login may occur at any suitable instance, e.g., before, during, or after navigating to an online resource, before, during, or after the activity relying on identifying information, etc.

Rather than providing a conventional login request, e.g., a username and password associated with a user account, the user, via the user device, may provide a login request identifying the user via a virtual number, e.g., a virtual interaction item number. In this example, the user may provide a virtual credit card number. However, in other examples, any suitable virtual number may be used. In some instances, the virtual credit card number may act as a username, and other information associated with the virtual credit card may act as a password, e.g., an expiration date and/or a security code. In some instances, only the virtual credit card number may be provided. In this manner, a login request may be provided that is an anonymous request that does not include personally identifying information associated with the user

The server system, upon receiving the login request, may validate the login request. For instance, the server system may include and/or access a validation algorithm configured to verify a virtual number. In some instances, a virtual number may, in a manner similar to a conventional credit card number, be validated by processing the virtual number with a predetermined validation algorithm. In other words, the validation algorithm may be usable to determine whether the virtual number is a number that could have been validly issued by an entity associated with the virtual number. In some instances, such as where the server system includes or has access to the validation algorithm, the server system may be able to validate the virtual number without needing to contact the entity associated with the virtual number. In some instances, the validation algorithm may be configured to validate numbers associated with a plurality of entities, and/or identify which entity is associated with a particular number. The server system, e.g., via the validation algorithm and/or another algorithm may identify the entity associated with the virtual number provided in the login request.

In some instances, after validating the request, the server system may approve the login request. In some instances, this may include associating actions performed by the user with the provided virtual number. In some instances, this may include initiating a session of the website on the server system associated with the login and/or with the virtual number, whereby actions taken by the user are associated with the session.

The user may, via the user device, proceed with one or more activities. For example, the user may add items to a shopping cart (e.g., a virtual container) for the purchase and/or delivery thereof. The user may, via the user device, submit an interaction-completion request, e.g., a checkout request. In response to receiving the interaction-completion request, the server system may transmit a user information request to the entity associated with the virtual number. The server system may receive a reply from the entity associated with the virtual number.

The reply may include personally identifying information for the user, e.g., address and/or payment information. For instance, the entity associated with the virtual number may store personally identifying information for users, and may only provide information for a particular user, via the reply, based on the virtual number received in the user information request.

The reply may include an encryption key configured to decrypt encrypted personally identifying information for the user. For example, the server system may include and/or have access to encrypted user information, and the entity associated with the virtual number may, via the reply, provide the server system with an encryption key usable only to decrypt information associated with the virtual number and/or for this login.

In response to receiving the reply, the server system may complete the interaction-completion request using the reply. For example, the server system may complete the user's checkout request using payment information and/or address information provided via the reply. In some instances, the user may provide identifying information not included in the reply, and/or may be able to edit information received via the reply. After completing the interaction-completion request, the server system may delete or remove access to the personally identifying information of the user. Through one or more of the techniques discussed above, the user may limit what identifying information is provided to an entity and when. Further, such techniques may not only reduce the burden of the user of entering information to each entity they interact with, but also may silo such information within the entity associated with the virtual number. This may facilitate the activities of the user and/or decrease the number of vectors of possible exposure of their identifying information.

In another exemplary use case, a user may not login to an online resource prior to initiating and/or completing an activity relying on identifying information. For example, the user, via the user device, may add one or more items to an online shopping cart (e.g., a virtual container) without having logged in to any account. Upon completing the activity, e.g., upon the user submitting an interaction-completion request, the website may prompt the user to login. The user may then login using a virtual number in a manner similar to the example above. In other words, the login request from the user may be received after the interaction-completion request, but prior to transmitting any user information request to any entity. The server system may validate the login, request user information from the entity associated with the virtual number, and may complete the interaction-completion request using information from a reply. In some instances, a user that logged in via a virtual number may benefit from a streamlined interaction-completion process. For example, a user checking out from an e-commerce merchant may, after logging in via a virtual number, engage in a single step, e.g., one click, check out process since details like the user's address, payment information, or the like are obtained via the user information request rather than via user input.

In some instances, the login may be a “guest” login, e.g., a login performed when no account associated with the login was previously generated, and/or for which the user desires that no information be retained by the server system. Generally, a guest login enables a user to withhold identifying information or request that such information not be retained. However, such a guest login generally means that the user is unable to access information about previous activities or benefit from other factors generally available when identifying information is retained, e.g., incentives, price matching, product recommendations, rewards, etc. In other words, conventionally, a user is forced to choose between privacy and utility.

However, by performing a guest login using a virtual number, a persistent guest login, e.g., a guest login that persists across multiple logins, may be used. For example, although the server system may not retain identifying information of the user or the activities, the user may request or authorize the entity associated with the virtual number to do so. For example, the entity associated with the virtual number may store a record of user-information requests, e.g., in order to maintain a user history that is opaque to entities interacted with by the user.

While several of the examples above involve purchasing a product or service from an online merchant, it should be understood that techniques according to this disclosure may be adapted to any suitable type of interaction with an entity online. For example, a governmental entity such as a department of motor vehicles may require identification and validation of a user's identity prior to authorizing or processing an interaction. An online data store may require identification and validation of a user's identity prior to providing the user with access to upload or download data. A financial institution may require identification and validation of a user's identity prior to enabling the user to access the user's accounts and/or authorizing the user to access, deposit, or transfer contents of such accounts. It should also be understood that the examples above are illustrative only. The techniques and technologies of this disclosure may be adapted to any suitable activity.

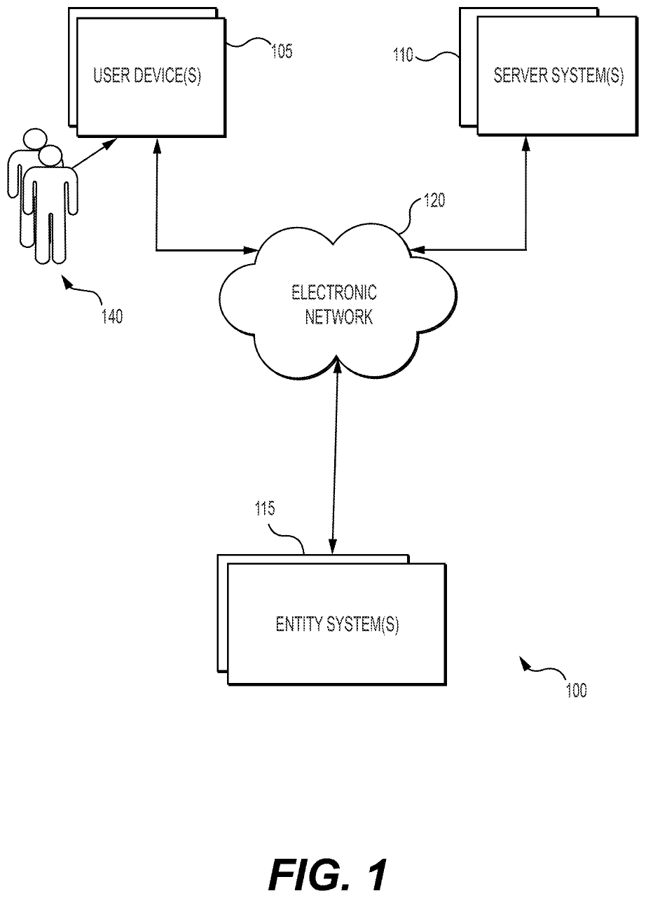

FIG. 1 depicts an exemplary environment 100 that may be utilized with techniques presented herein. One or more user device(s) 105, one or more entity system(s) 115, and one or more server system(s) 110 may communicate across an electronic network 120. The user device 105 may be associated with a user 140, e.g., a user that has a virtual number and/or an account with the entity system 115, a user that desires to perform an interaction with the server system 110, or the like.

In some embodiments, one or more of the components of the environment 100 are associated with a common entity, e.g., a financial institution, transaction processor, merchant, or the like. In some embodiments, one or more of the components of the environment is associated with a different entity than another. The systems and devices of the environment 100 may communicate in any arrangement. As will be discussed herein, systems and/or devices of the environment 100 may communicate in order to one or more of identify and validate a user via a virtual number, perform or facilitate anonymized interactions, provide secure access to personally identifying data of a user, or the like.

The user device 105 may be configured to enable the user 140 to access and/or interact with other systems in the environment 100. For example, the user device 105 may be a computer system such as, for example, a desktop computer, a mobile device, a tablet, etc. In some embodiments, the user device 105 may include one or more electronic application(s), e.g., a program, plugin, browser extension, etc., installed on a memory of the user device 105. In some embodiments, the electronic application(s) may be associated with one or more of the other components in the environment 100. For example, the electronic application(s) may include one or more of a shopping portal associated with server system 110, a financial portal associated with the entity system 115, etc.

In various embodiments, the electronic network 120 may be a wide area network (“WAN”), a local area network (“LAN”), personal area network (“PAN”), or the like. In some embodiments, electronic network 120 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

The server system 110 may host and/or implement one or more websites, e.g., that are accessible to the user device 105 via the network 120. The server system 110 may include any suitable number of servers or other devices such as, for example, one or more data storage systems. In an example, the server system 110 may store data associated with one or more products or services offered via a hosted website. In another example, the server system 110 may store data associated with users 140 that perform interactions with the server system 110 via the website, e.g., user history, user account information, user address information, user payment information, user demographic information, etc. In a further example, the server system 110 may store data similar to the foregoing, but associated with a virtual number rather than a user.

In some embodiments, the server system 110 may include one or more authentication or validation algorithms or modules. For example, the website hosted or implemented by the server system 110 may be configured to prompt a user 140, e.g., via an interface on the user device 105, for login information and/or account information, and the server system 110 may compare such login information with stored user account information, or the like. In another example, the server system 110 may include an algorithm or module for validating a virtual number, a payment instrument, or the like. In some instances, a payment instrument such as a credit card may be associated with a payment account number, e.g., a credit card number. Such number may include one or more detectable features that are usable to determine the validity of the payment instrument. For example, by applying a predetermined algorithm to a credit card number, it may be possible to identify whether the credit card number is a valid number that could have been issued, and/or which entity issued the associated credit card. In some instances, a virtual number, e.g., a virtual credit card number, may have similar characteristics, and thus may be validated in a similar manner via a similar or even the same algorithm or module. Generally, a virtual number is associated with a user account or a payment account, as discussed in further detail below.

In some embodiments, at least a portion of the data stored on the server system 110 may be stored in an encrypted or secured manner. For example, in some instances, accessing and/or using a portion of the stored data may require an encryption key, passcode, or the like, as discussed in further detail below.

In some embodiments, the server system 110 is configured to initiate a session for a particular user 140, e.g., upon a login by the user 140 via the user device 105. A session generally encompasses tracking and/or persistence of interactions between the user 140 and the website, secure handling of information, e.g., via encryption, or the like. In some embodiments, initiating a session may include generating a number or token associated with the session, whereby such number or token may be passed between the user device 105 and the server system 110, e.g., to disambiguate actions taken by the user 140 in the session from other actions taken by other users or devices. In some embodiments, initiating a session may include generating a secure communication channel between the user device 105 and the server system 110.

In some embodiments, the entity system 115 may be associated with a financial institution, a banking institution, a payment processor, or the like. For example, in some embodiments, the entity system 115 may include or be associated with an issuer that issues instruments such as credit cards, virtual numbers, or the like. The entity system 115 may store information similar to that which may be stored by the server system 110, e.g., user history data, user account information, payment information or virtual number information associated with the user 140, user address information, etc. The entity system 115 may include one or more algorithms usable to issue or generate instruments such as a credit card or a virtual number, etc. In some embodiments, the entity system 115 may include or have access to user financial information, e.g., that may be usable to perform a credit check or the like.

The entity system 115 may include one or more algorithms for processing information and/or payment requests, as discussed in further detail below. In some embodiments, user account information, user history, and/or virtual number information for a user that is stored by the entity system 115 may be associated with one or more websites or server system 110. For example, as discussed in further detail below, the entity system 115 may store information regarding a user 140's interactions on a website, e.g., so that the website does not need to and/or so as to ensure that the user 140's information is centrally protected.

In some embodiments, the entity system 115 may include one or more data security features such as, for example, restricted access or access control measures, encryption, active or passive monitoring, etc. For example, the entity system 115 may be configured to provide personally identifying data of a user only to a requesting source that is previously known. In some embodiments, as discussed in further detail below, the entity system 115 may make available only such information as necessary to process an interaction, and/or may remove such availability or cause deletion of such data after the interaction is complete.

Although depicted as separate components in FIG. 1, it should be understood that a component or portion of a component in the environment 100 may, in some embodiments, be integrated with or incorporated into one or more other components. For example, a portion of the user device 105 may be integrated into the server system 110 or the like. In another example, the entity system 115 may be at least partially integrated with the server system 110. In some embodiments, operations or aspects of one or more of the components discussed above may be distributed amongst one or more other components. Any suitable arrangement and/or integration of the various systems and devices of the environment 100 may be used.

In the following methods, various acts may be described as performed or executed by a component from FIG. 1, such as the server system 110, the user device 105, the entity system 115, or components thereof. However, it should be understood that in various embodiments, various components of the environment 100 discussed above may execute instructions or perform acts including the acts discussed below. An act performed by a device may be considered to be performed by a processor, actuator, or the like associated with that device. Further, it should be understood that in various embodiments, various steps may be added, omitted, and/or rearranged in any suitable manner. Also, it should be understood that the following methods may include additional operations or actions taken by additional persons or devices, and that such inclusion is to further illustrate the techniques or technologies discussed herein, and is not limiting on any particular embodiment.

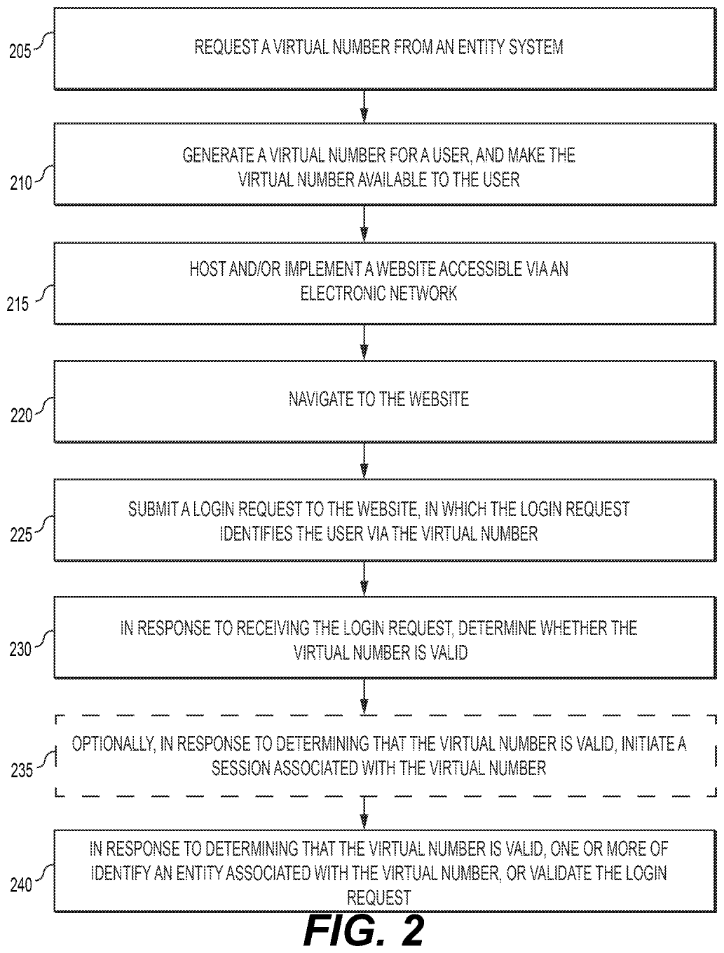

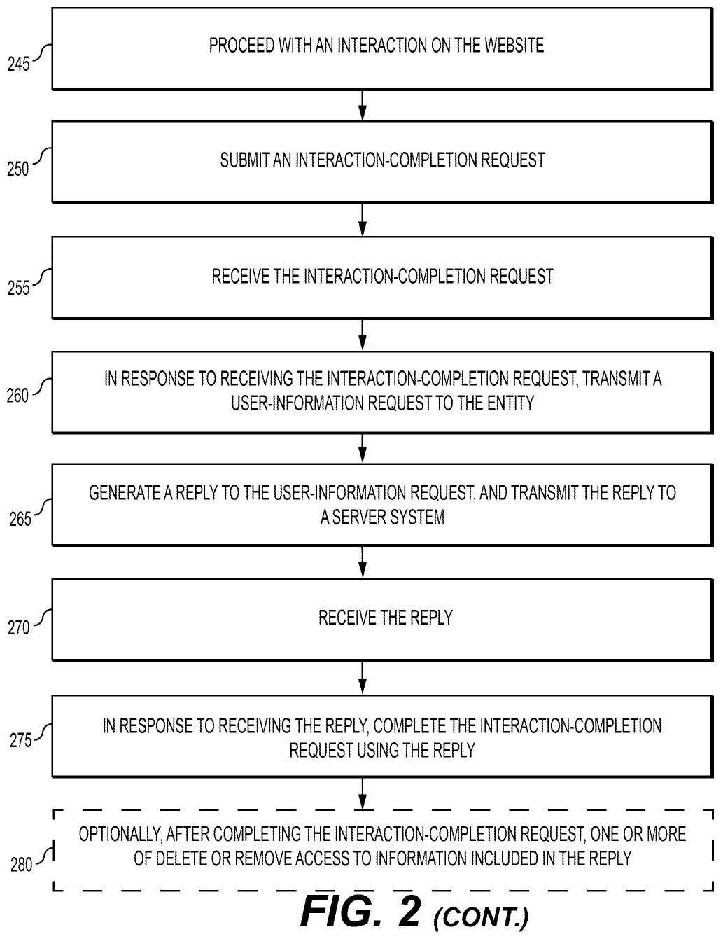

FIG. 2 illustrates an exemplary process for facilitating anonymized interactions, e.g., via identifying and/or validating a user via a virtual number, such as in the various examples discussed above. At step 205, a user 140, e.g., via a user device 105, may request a virtual number from an entity system 115. For example, the user 140 may request or may already have an account associated with the entity system 115, e.g., a payment account like a banking account or a credit card or the like. Generally, a virtual number generated for a user may be associated with such a user account. For instance, interactions conducted via a virtual number may be attributed to a user account by the entity system 115.

In some instances, the user 140 may submit the request for the virtual number by navigating the user device 105 to a website associated with or hosted by the entity system 115. In some embodiments, the user device 105 may be operating an electronic application or browser extension associated with the entity system 115 that enables the user 140 to submit the request while performing an interaction with a server system 110. For example, the user 140 may be browsing a website for an online merchant. The user 140 may activate a button associated with the electronic application, e.g., to open a popup within which the user may request a virtual number. In another example, the electronic application or browser extension may monitor activity of the user 140, determine that the user is preparing to engage in or is engaging in an interaction with server system 110, and may prompt the user 140, e.g., via a popup window or the like, with a suggestion for a virtual number. Any other suitable technique for recommending and/or requesting a virtual number may also be used in various embodiments, e.g., via email, telephone, in person, etc.

At step 210, the entity system 115 may generate a virtual number for the user 140 and make the virtual number available to the user 140. The virtual number may be or include, for example, a virtual identification number, a virtual interaction item number such as a virtual credit card number, or the like. In various embodiments, making the virtual number available may include one or more of transmitting a message to the user device 105 that includes the virtual number, associating the virtual number with a virtual wallet of the user 140, or enabling or providing access to the virtual number on an electronic application operating on the user device 105, e.g., a browser, a banking application, a shopping application, etc. In some embodiments, additional information may be provided along with the virtual number, e.g., an expiration date, a security code, a name or pseudonym associated with the virtual number, an identification of an issuing entity, information regarding limitations of use, or the like.

Limitations of use may define interactions or activities for which the virtual number is authorized for use. Such limitations may be requested and/or required by the entity system 115, the user 140, or any other suitable party. Exemplary limitations may include, for example, one or more of authorizing interactions only with one or more pre-approved entities (e.g., for SHOESTORE only, or any library, or an entity in a particular region, etc.), authorizing interactions only that pertain to a particular category of interactions (e.g., clothes, academic purposes, news, etc.), restrictions on time of use (e.g., time of day, day of the week, month, season, etc.), restrictions on amount or on frequency of interactions, or the like.

At step 215, the server system 110 may host and/or implement a website, e.g., that is accessible via an electronic network 120. At step 220, the user 140, via the user device 105, may navigate to the website. The website may include a prompt and/or option for the user 140 to submit a login request. Generally such a request requires that the user 140 generate or have previously generated a user account with the server system 110, which may require that the user 140 submit personally identifying information, such as a name, age, address, payment information, or the like. However, the user 140 may desire to protect their personally identifying information, e.g., by limiting a number of entities to which such information is provided, by proceeding with an interaction anonymously, or the like.

At step 225, the user 140, via the user device 105, may submit a login request to the website, in which the login request identifies the user 140 via the virtual number. In some embodiments, the virtual number may be used as a username for the login request. In some embodiments, other information associated with the virtual number, such as a security code or expiration data may be used as a password for the login request. In some embodiments, the website may include an alternative login prompt configured to receive a virtual number, e.g., without additional information. In some embodiments, the login request may be an anonymous request, e.g., that does not include personally identifying information associated with the user 140.

In some embodiments, the server system 110 may not include preexisting account information associated with the virtual number in the login request. For example, the user 140 may not have previously used the virtual number with the server system 110, information regarding the user 140 and/or the virtual number may have been deleted or restricted from the server system 110, or the like. In some embodiments, it may be beneficial to enable the user 140 to proceed with an interaction with the server system 110 without requiring registration of a user account, e.g., to reduce interruption or inconvenience to the user 140. In some embodiments, it may be beneficial for the server system 110 to be able to verify and/or authenticate a login request without relying on a user account.

At step 230, the server system 110 may, in response to receiving the login request that identifies the user via the virtual number, determine whether the virtual number is valid. In other words, the server system 110 may determine whether the virtual number is a virtual number that could have been legitimately issued by an issuing entity. In some embodiments, the server system 110 may apply and/or employ a validation algorithm or the like on the virtual number to determine its validity. Such an algorithm may be usable to identify an issuing entity associated with the virtual number and/or determine whether the virtual number is valid. In some embodiments, the server system 110 may transmit a validation request to an entity system 115 associated with the issuing entity, whereby such entity system 115 may respond with a rejection or a validation confirmation.

At step 235, optionally, in response to determining that the virtual number is valid, the server system 110 may initiate a session associated with the virtual number. For example, the server system 110 may generate a unique identifier associated with the virtual number, e.g., that would be referenced and/or included in communications between and/or interactions with the server system 110 and user device 105. In some embodiments, interactions and/or communications associated with the session may be secured, e.g., via a secure communication channel, or encrypted, or the like.

At step 240, in response to determining that the virtual number is valid at step 230, the server system 110 may one or more of identify the entity associated with the virtual number, e.g., the issuing entity, or validate the login request. Validating the login request may include, for example, enabling the user 140 to proceed with an interaction via the user device 105, authorizing access to at least one restricted portion of the website or at least one restricted action enabled by the website, associating actions taken by the user 140 via the user device 105 with the virtual number, or the like. The identification of the entity may be based on an output of a validation algorithm or the like. For example, a validation algorithm may be configured to not only determine whether a virtual number is valid, but also determine an identification of a potential issuing entity.

At step 245, the user 140, via the user device 105, may proceed with an interaction with the server system 110, e.g., by taking one or more actions on the website. For example, the user 140 may, for example, one or more of browse for one or more products or services, add one or more products or services to an electronic shopping cart (e.g., a virtual container), request information, upload or download information, schedule a service or delivery, generate a posting, view content or media, etc.

At step 250, the user 140, via the user device 105, may submit an interaction-completion request to the server system 110. For example, the user 140 may submit a checkout request, e.g., by activating a checkout button or the like. Any other suitable action may be used in various embodiments.

At step 255, the server system 110 may receive the interaction-completion request. In some embodiments, the interaction-completion request may be received through or in association with the session initiated for the user 140 and/or the virtual number at step 235.

At step 260, in response to receiving the interaction-completion request, the server system 110 may transmit a user-information request to the entity associated with the virtual number, e.g., the issuing entity. For example, the server system 110 may transmit the user-information request to an entity system 115 associated with the issuing entity. In some embodiments, the user-information request includes additional information associated with the virtual number such as, for example, an expiration date, a security code, or the like. In some embodiments, the user-information request includes information associated with the interaction, e.g., a time of the interaction, a category of the interaction, one or more products associated with the interaction, an amount for the interaction, an identification of an entity associated with the server system 110, etc.

At step 265, the entity system 115 may generate a reply to the user-information request, and transmit the reply to the server system 110. In some embodiments, generating the reply may include, for example, accessing information associated with the user 140 such as user account information, user history, user payment information, user demographic information, etc. For example, the virtual number may act as an index or identifier for information associated with the user 140 that is stored by or accessible to the entity system 115.

In some embodiments, the reply generated by the entity system 115 may include personally identifying information for the user such as, for example, an address associated with the user 140, a name for the user 140, payment information for the user 140, interaction restrictions for the virtual number, etc.

In some embodiments, generating the reply may include comparing information associated with the interaction included with the user-information request with information associated with the user 140. For example, the entity system 115 may determine whether the interaction restrictions for the virtual number authorize or prohibit the interaction. If the interaction would be prohibited, the reply may include a rejection. Conversely, if the interaction would be authorized the reply may include an authorization and/or the information to be included in the reply discussed above. In another example, the entity system 115 may compare one or more characteristics of the interaction with user history or other data, e.g., in order to determine a likelihood that the interaction is fraudulent or not.

In some embodiments, the entity system 115 may not directly store and/or have access to personally identifying data of the user 140. For example, personally identifying data of the user 140 stored by the entity system 115 and/or by another system may be stored in an encrypted form. Thus, in some embodiments, the reply generated by the entity system 115 may include an encryption key configured to enable access to encrypted personally identifying data of the user 140. In other words, the encryption key in the reply may enable the server system 110 to one or more of access or decrypt personally identifying data of the user 140 stored by the server system 110 or another system.

In some embodiments, generating the reply may include validating the virtual number, e.g., instead of or in addition to the validation determined by the server system 110 above. For example, the entity system 115 may determine whether the virtual number was previously associated with the user 140.

At step 270, the server system 110 may receive the reply transmitted by the entity system 115 and, at step 275, the server system 110 may, in response to receiving the reply, complete the interaction-completion request using the reply. For example, the rely may include an address for the user 140, and competing the interaction-completion request using the reply may include automatically using the address for the user 140, e.g., as a delivery destination for a product or service selected by the user 140. In some embodiments, completing the interaction-completion request may include automatically using the virtual number to complete the interaction-completion request. For example, in embodiments in which the virtual number is a virtual credit card number, completing the interaction-completion request may include processing a payment transaction using the virtual credit card number.

In this manner, e.g., using personally identifying information for the user 140 obtained via the reply, the interaction may be completed without requiring that the user 140 enter or re-enter such information into website. Further, the techniques discussed above regarding how the personally identifying information for the user 140 is obtained may reduce a risk of the personally identifying information for the user 140 becoming exposed.

Optionally, at step 280, the server system 110 may, after completing the interaction-completion request using the reply, one or more of delete or remove access to the information included in the reply. For example, the server system 110 may delete the encryption key included in the reply, information obtained via the encryption key, and/or other information included in or obtained via the reply. Deleting or removing access to such information may reduce a burden on the server system 110 to secure and store personally identifying information, and may reduce the risk of such information being exposed.

In some embodiments, completing the interaction-completion request and/or deleting or removing access to information from the reply may include concluding the session associated with the virtual number.

Although the foregoing method including the user 140 logging into the website prior to taking one or more actions further to the interaction, it should be understood that, in various embodiments, the log in of the user may occur at any suitable point in time or at any suitable step in the foregoing method. For example, in some embodiments, a user may take one or more actions further to the interaction such as described in connection with step 245 above, e.g., add one or more items to an electronic shopping cart, and may log in or be prompted to log in prior to or upon checking out in which the login request or login identifies the user via the virtual number as described in connection with step 225 above. In an exemplary embodiment, the user 140 may submit an interaction-completion request prior to logging in, whereby the user 140 may then be prompted to log in. After the user 140 logs in, e.g., in a manner similar to that discussed above, the server system 110 may then transmit the user-information request to the entity system 115.

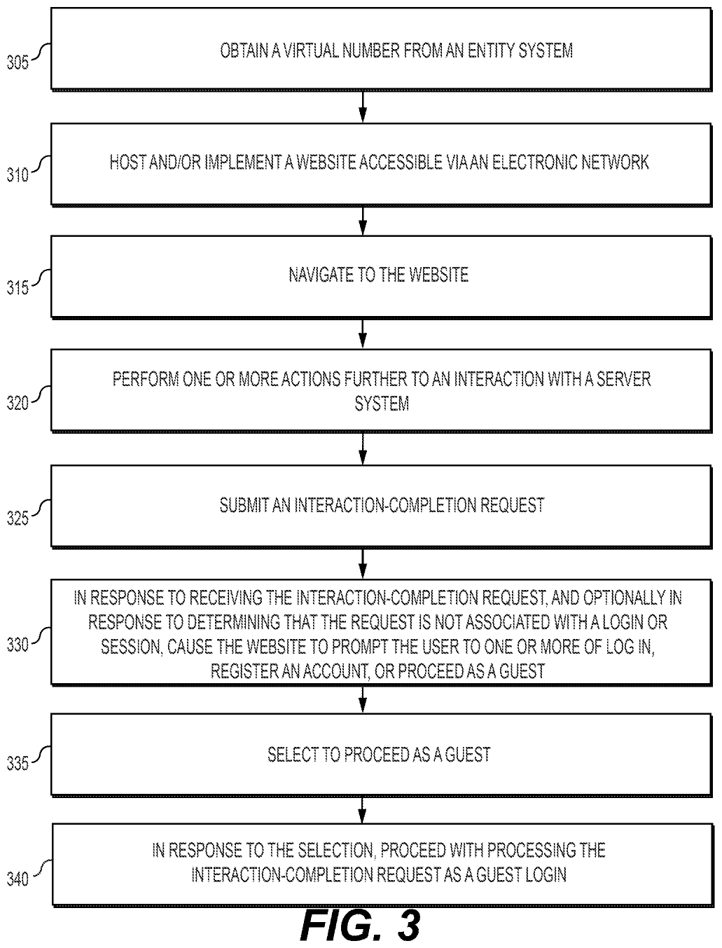

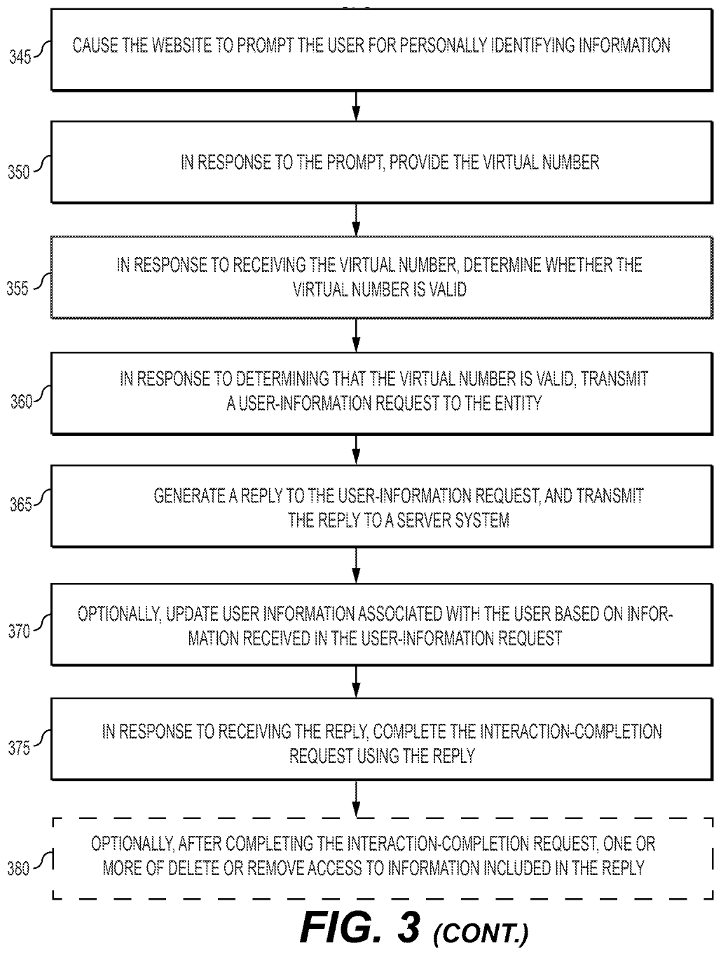

In some embodiments, the user 140 may not desire to log in to the website, even with a virtual number as set forth in the example above. Thus, in some embodiments, the user 140 may complete an interaction using a guest login. FIG. 3 illustrates an exemplary process for facilitating anonymized interactions and/or identifying or validating a user 140 via a virtual number, according to one or more embodiments discussed above. At step 305, a user 140 may obtain a virtual number, e.g., in a manner similar to the discussion above regarding FIG. 2. At step 310, the server system 110 may implement or host the website. At step 315, the user 140, via the user device 105, may navigate to the website. At step 320, the user 140 may perform one or more actions further to an interaction with the server system 110.

At step 325, the user 140, via the user device 105, may submit an interaction-completion request to the server 110. At step 330, in response to receiving the interaction-completion request, and optionally in response to determining that the request is not associated with a login or a session, the server system 110 may cause the website to prompt the user 140 to select between one or more of logging in, registering a user account, or proceeding as a guest (e.g., a guest login). At step 335, the user may select to proceed as a guest. At step 340, in response to the selection, the server system 110 may proceed with processing the interaction-completion request as a guest login. In some embodiments, the server system 110 may log the user 140 in as a unique guest, e.g., by associating the user 140 with a guest account or the like. In other words, in some embodiments, the request to proceed as a guest may act as a guest login request. Thus, such a guest login request may be received after the interaction-completion request has already been received.

At step 345, the server system 110 may cause the website to prompt the user 140 for personally identifying information, e.g., payment information, address information, identification information, or the like. At step 350, in response to the prompt, the user 140, via the user device 105 may, instead of or in addition to providing at least a portion of such personally identifying information, provide the virtual number. In one example, the user 140 may provide the virtual number as a virtual credit card number for payment information. In another example, the website may be configured to enable the user 140 to supply the virtual number in lieu of the other requested personally identifying information.

At step 355, in response to receiving the virtual number, the server system 110 may determine whether the virtual number is valid. At step 360, in response to determining that the virtual number is valid, the server system 110 may transmit a user-information request to an entity system 115 associated with the virtual number. Thus, the transmission of the user-information request may occur after the receipt of the interaction-completion request. At step 365, the entity system 115 may generate a reply to the user-information request and transmit the reply to the server system 110.

Optionally, at step 370, the entity system 115 may update user information associated with the user 140 based on information received in the user-information request. For example, the entity system 115 may track one or more of products or services selected by the user 140, a category for the information, an amount for the interaction, or the like. In some embodiments, such tracking and/or recording of such information may be specified by the user 140, e.g., when requesting the virtual number or via a user interaction with the entity system 115 or an associated electronic application or the like. In this manner, the user 140 may receive the benefits of having a user account, e.g., personalized recommendations, incentives, bonus offers, rewards, or the like, without needing to register a user account with the server system 110. In some embodiments, the entity system 115 may include in the reply one or more of an incentive, offer, benefit, request for rewards points, or the like that may be applicable to the interaction, e.g., so that such may be applied to the user 140 despite the user 140 checking out as a guest.

At step 375, the server system 110 may use the reply to complete the interaction-completion request. In this manner, the user 140 may be able to complete an interaction as a guest and without needing to provide the server system 110 with personally identifying information. At step 380, the server system 110 may delete or remove access to the information received in the reply.

It should be understood that embodiments in this disclosure are exemplary only, and that other embodiments may include various combinations of features from other embodiments, as well as additional or fewer features. For example, while some of the embodiments above pertain to a user login, any suitable activity may be used. In an exemplary embodiment, the identifying and validating operations discussed above may be used to determine a likelihood that the interaction is fraudulent or not. In an example, details of an interaction may be compared against user history and/or historical fraudulent interactions in order to predict whether an interaction is fraudulent.

In general, any process or operation discussed in this disclosure that is understood to be computer-implementable, such as the processes illustrated in FIGS. 2 and 3, may be performed by one or more processors of a computer system, such any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

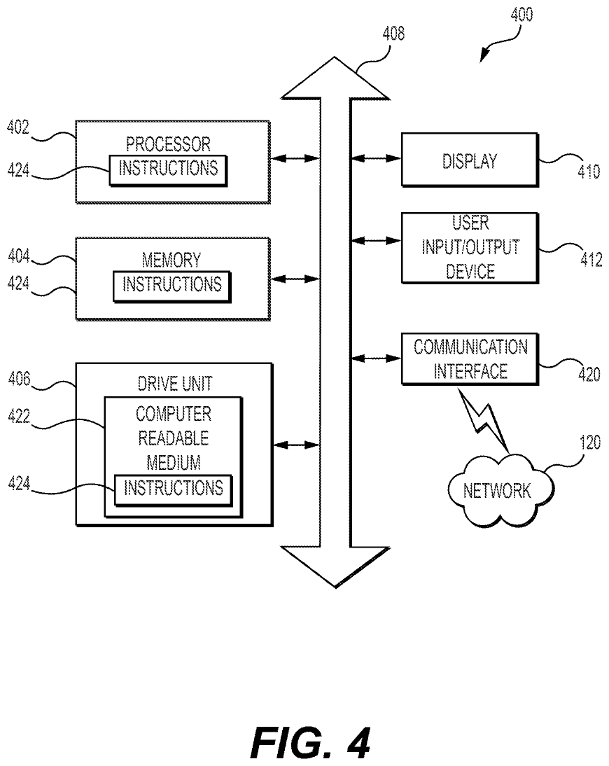

FIG. 4 is a simplified functional block diagram of a computer 400 that may be configured as a device for executing the methods of FIGS. 2 and 3, according to exemplary embodiments of the present disclosure. For example, the computer 400 may be configured as the server system 110, the user device 105, the entity system 115 and/or another system according to exemplary embodiments of this disclosure. In various embodiments, any of the systems herein may be a computer 400 including, for example, a data communication interface 420 for packet data communication via network 120. The computer 400 also may include a central processing unit (“CPU”) 402, in the form of one or more processors, for executing program instructions. The computer 400 may include an internal communication bus 408, and a storage unit 406 (such as ROM, HDD, SDD, etc.) that may store data on a computer readable medium 422, although the computer 400 may receive programming and data via network communications. The computer 400 may also have a memory 404 (such as RAM) storing instructions 424 for executing techniques presented herein, although the instructions 424 may be stored temporarily or permanently within other modules of computer 400 (e.g., processor 402 and/or computer readable medium 422). The computer 400 also may include input and output ports 412 and/or a display 410 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, an automobile entertainment system, a home entertainment system, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for anonymized interactions, comprising:
receiving, via at least one processor of a server system, a login request from a user device associated with a user, the login request identifying the user via a virtual interaction item number;
in response to receiving the login request, determining, via the at least one processor, whether the virtual interaction item number is valid;
in response to determining that the virtual interaction item number is valid:
validating the login request; and
identifying an entity associated with the virtual interaction item number;
receiving, via the at least one processor and from the user device, an interaction-completion request;
in response to receiving the interaction-completion request, transmitting a user information request to the entity associated with the virtual interaction item number;
receiving a reply to the user-information request from the entity associated with the virtual interaction item number; and
in response to receiving the reply, completing the interaction-completion request using the reply.

2. The method of claim 1, wherein the login request is an anonymous request that does not include personally identifying information associated with the user.

3. The method of claim 1, wherein the login request is a guest login request.

4. The method of claim 3, wherein the guest login request is received after the interaction-completion request, but prior to transmitting the user information request.

5. The method of claim 1, further comprising:
in response to determining that the virtual interaction item number is valid, initiating a session associated with the virtual interaction item number for the user device;
wherein the interaction-completion request is received through the session associated with the virtual interaction item number.

6. The method of claim 1, wherein the reply from the entity associated with the virtual interaction item number includes personally identifying information for the user.

7. The method of claim 6, wherein the personally identifying information for the user includes an address associated with the user, such that the address of the user is automatically used to complete the interaction-completion request.

8. The method of claim 1, wherein the reply from the entity associated with the virtual interaction item number includes an encryption key configured to decrypted encrypted personally identifying information for the user.

9. The method of claim 1, further comprising, after completing the interaction-completion request using the reply, one or more of deleting or removing access to information included in the reply.

10. The method of claim 1, further comprising, automatically using the virtual interaction item number to complete the interaction-completion request.

11. A system for facilitating anonymized interactions, comprising:
at least one processor; and
at least one memory operatively connected to the at least one processor, and storing instructions executable by the at least one processor to perform operations, including:
receiving a login request from a user device associated with a user, the login request identifying the user via a virtual interaction item number;
in response to receiving the login request, determining whether the virtual interaction item number is valid;
in response to determining that the virtual interaction item number is valid:
validating the login request; and
identifying an entity associated with the virtual interaction item number;
receiving, from the user device, an interaction-completion request;
in response to receiving the interaction-completion request, transmitting a user information request to the entity associated with the virtual interaction item number;
receiving a reply to the user-information request from the entity associated with the virtual interaction item number; and
in response to receiving the reply, completing the interaction-completion request using the reply.

12. The system of claim 11, wherein the login request is an anonymous request that does not include personally identifying information associated with the user.

13. The system of claim 11, wherein:
the login request is a guest login request; and
the guest login request is received after the interaction-completion request, but prior to transmitting the user information request.

14. The system of claim 11, wherein the operations further include:
in response to determining that the virtual interaction item number is valid, initiating a session associated with the virtual interaction item number for the user device;
wherein the interaction-completion request is received through the session associated with the virtual interaction item number.

15. The system of claim 11, wherein the reply from the entity associated with the virtual interaction item number includes personally identifying information for the user.

16. The system of claim 15, wherein the personally identifying information for the user includes an address associated with the user, such that the address of the user is automatically used to complete the interaction-completion request.

17. The system of claim 11, wherein the reply from the entity associated with the virtual interaction item number includes an encryption key configured to decrypted encrypted personally identifying information for the user.

18. The system of claim 11, wherein the operations further include:
after completing the interaction-completion request using the reply, one or more of deleting or removing access to information included in the reply.

19. The system of claim 11, wherein the operations further include automatically using the virtual interaction item number to complete the interaction-completion request.

20. A computer-implemented method for anonymized interactions, comprising:
receiving, via at least one processor of a server system, a login request from a user device associated with a user, the login request identifying the user via a virtual interaction item number;
in response to receiving the login request, determining, via the at least one processor, whether the virtual interaction item number is valid;
in response to determining that the virtual interaction item number is valid:
validating the login request;
identifying an entity associated with the virtual interaction item number; and
initiating a session associated with the virtual interaction item number for the user device;
receiving, via the at least one processor and from through the session associated with the virtual interaction item number, an interaction-completion request;
in response to receiving the interaction-completion request, transmitting a user information request to the entity associated with the virtual interaction item number;
receiving a reply to the user-information request from the entity associated with the virtual interaction item number;
in response to receiving the reply, completing the interaction-completion request using the reply and the virtual interaction item number; and
after completing the interaction-completion request, one or more of deleting or removing access to information included in the reply.
